(19) United States
(12) Patent Application Publication
(10) Pub. No.: US 2006/0078403 A1
(43) Pub. Date: Apr. 13, 2006

(54) Method for the production of a screw, and screw produced according to said method

(75) Inventors: Thomas Matzler, Rebstein (CH); Ernst Rohner, Thal (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: SFS-Intec Holding AG, Heerbrugg (CH)

(21) Appl. No.: 10/535,694

(22) PCT Filed: Dec. 17, 2003
(86) PCT No.: PCT/EP03/14384

§ 371 Date: May 19, 2005

(30) Foreign Application Priority Data
Dec. 23, 2002 (DE) 102 60 828.8

(51) Int. Cl. F16B 23/00

(52) U.S. Cl. 411/402

(57) ABSTRACT

A screw (1) having a head (2), a shaft (4) that includes a thread (5), and an interior engaging member (3) in the head is provided. The screw (1) is produced from an ultra-high strength steel using a cold forming method.

### BACKGROUND

The invention relates to a method for the production of a screw, in particular a screw for indexable inserts, provided with an interior engaging member and a screw.

The production of screws by way of cold forming of a source material has been known per se in several variants. Problems only arise with high-strength source material. Here, it has previously been understood that exclusively cutting, i.e. production by way of material removal can be used. Such a production of screws entails a high expense and is therefore very costly. Those skilled in the art still believe that beyond a certain level of strength of the source material, the production of screws with an interior engaging member by way of cold forming is impossible, particularly for relatively small screws.

### SUMMARY

The object of the present invention is to overcome the prior mindset of those skilled in the art and to provide the ability for producing screws with an interior engaging member made from a high-strength material.

This is attained according to the invention in a method, in which ultrahigh-strength steel is used and in which a screw including the interior engaging member is produced by cold forming of the source material.

Through a series of experiments it has been determined that those skilled in the art were erroneous in the prior belief, based on seemingly impossible facts, and that it is actually quite possible to produce screws made from ultrahigh-strength steel using a method of cold forming according to the invention. Such screws have considerably better strength characteristics in reference to screws made by cutting due to the best possible cross-section ratios. In the previously used production method, the wrench socket in the head could only be produced by way of predrilling and subsequently producing the contour of the wrench by way of punching. However, using the production method of cold forming, the contour of the wrench, e.g., a hexagon socket, is produced by way of a cold forming pressing process without any preliminary drilling. Therefore, the opening in the wrench socket requires considerably less depth than the same result achieved by the prior process, which includes predrilling. Therefore, the strength is considerably higher at the point of transition from screw head to shaft, because a lot more material thickness remains between the opening for the wrench socket and the exterior contour. Therefore, the weak spots that develop during cutting are avoided.

Accordingly, the best features for accepting strong torque and also for achieving great tensile strength result from a screw, in particular a screw with an interior engaging member, made from ultrahigh-strength steel and produced by way of cold forming and which can be used with indexable inserts.

Although attempts have already been made to produce screws from ultrahigh-strength steel, limits seemed to appear when an interior engaging member was also produced. The present invention overcomes the bias that was previously held by those skilled in the art.

It is particularly advantageous for such a method and a screw made according to such a method if the source material used is an ultrahigh-strength steel with the composition C 0.03, Mo 5.0, Ni 18.5, Co 8.5, Ti 0.6, Al 0.1, moiety Fe. Particularly with such a composition, those skilled in the art previously thought that any production via cold forming would not be possible. The present invention proves the opposite.

### BRIEF DESCRIPTION OF THE DRAWINGS

Additional features and particular advantages of the invention will be explained in greater detail in the following description using the drawings. They show:

FIG. 1 a side view of a screw, shown partially cut open;

FIG. 2 a top view of the head of the screw.

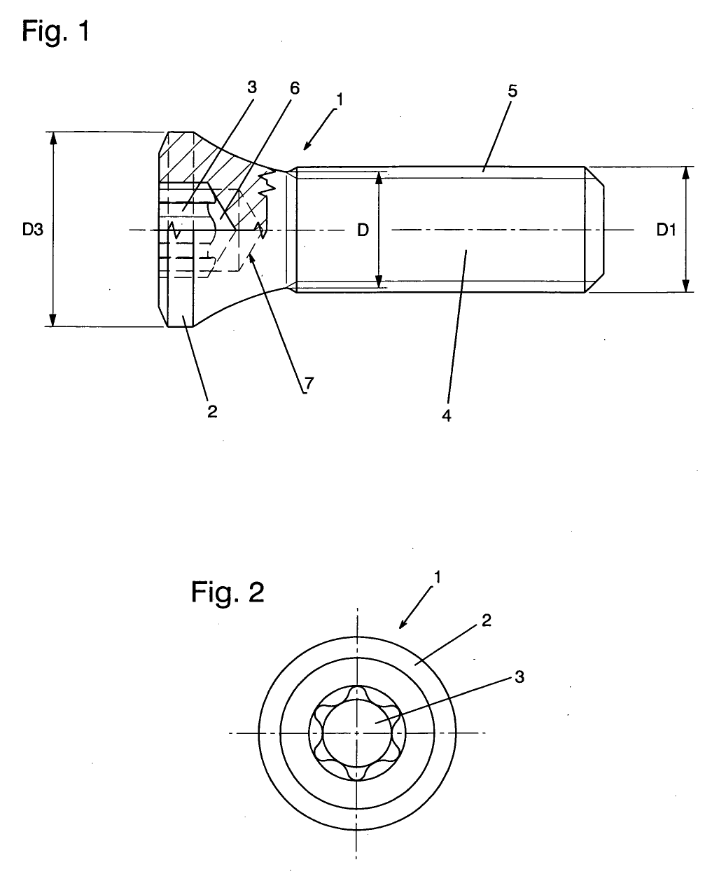

### DETAILED DESCRIPTION OF THE PREFERRED EMBODIMENTS

In the drawing, an exemplary embodiment of a screw is shown that is used for fastening indexable inserts. The measures according to the invention can similarly apply to screws used for other purposes, of course. It has been shown particularly in screws, that have to be produced within narrow tolerances and are primarily subject to torque and tensile stress, that the screws made by way of cold forming are considerably better than screws made by cutting. Due to the fact that ultrahigh-strength steel are the best source material for such screws, such screws were previously made as turned parts, because one skilled in the art considered the production by way of cold forming being an impossibility.

A screw 1 shown in the drawing, made particularly for fastening indexable inserts, comprises a head 2 and a shaft 4 provided with a thread 5. On the shaft 4, having the diameter D, the thread 5 is rolled with the exterior diameter D1. The head 2 in the shape of a raised countersunk head, has a diameter D3. In the head 2 an interior engaging member 3 is formed for accepting a drive element. During the production in the cold forming process only a small indentation 6 is developed at the bottom of the interior engaging member 3. In the previously known production methods by way of cutting, a bore 7 (shown in dashed lines) had to be made first for producing the interior engaging member 3, formed as deep as necessary, in order to subsequently produce the wrench socket in a punching process. Based on the rather different sections having various diameters, a relatively large degree of formation must be considered with this being deemed not possible when ultrahigh-strength steel was used.

In the method according to the invention used for producing the screw, in particular a screw for indexable inserts, the production occurs by way of cold forming of the source material, with ultrahigh-strength steel being used as the source material, which used to be considered impossible by the experts. Within the scope of the invention any type of ultrahigh-strength steel can be processed by way of cold forming of the source material, however, in the present case, however a source material of an ultrahigh-strength steel with the composition C 0.03, Mo 5.0, Ni 18.5, Co 8.5, Ti 0.6, Al 0.1, moiety Fe is considered particularly suitable.

This invention allows the production of a screw, in particular, a screw for indexable inserts, which comprises ultrahigh-strength steel and is made by way of cold forming. Therefore, essential improvements with regard to the strength of the screw are achieved.

The method for producing the screw uses additional processing steps, similar to the ones used in other cold forming methods, for example wash cycles, milling processes for chamfering, grinding, thread rolling, finishing, final quality control etc.

1. A method for producing a screw provided with an interior engaging member, comprising: using ultrahigh-strength steel as a source material and cold forming the screw including the interior engaging member from the source material.

2. A method according to claim 1, wherein the ultrahigh-strength steel has a of composition C 0.03, Mo 5.0, Ni 18.5, Co 8.5, Ti 0.6, Al 0.1, moiety Fe.

3. A screw, indexable inserts, comprising ultrahigh-strength steel formed with head having an interior engaging member, by way of cold forming.

4. A screw according to claim 3, wherein the ultrahigh-strength steel has a composition of C 0.03, Mo 5.0, Ni 18.5, Co 8.5, Ti 0.6, Al 0.1, moiety Fe.
